(19) United States
(12) Patent Application Publication
(10) Pub. No.: US 2009/0113439 A1
(43) Pub. Date: Apr. 30, 2009

(54) Method and Apparatus for Processing Data

(75) Inventors: Thomas Zettler, Hoehenkirchen-Siegertsbrunn (DE); Gunther Fenzl, Neubiberg (DE)

Correspondence Address: COATS & BENNETT/INFINEON TECHNOLOGIES, 1400 CRESCENT GREEN, SUITE 300, CARY, NC, 27518, US

(73) Assignee: INFINEON TECHNOLOGIES AG, Neubiberg (DE)

(21) Appl. No.: 12/261,264

(22) Filed: Oct. 30, 2008

(30) Foreign Application Priority Data
Oct. 30, 2007 (DE) 102007051803.1

(51) Int. Cl. G06F 9/46

(52) U.S. Cl. 718/103

(57) ABSTRACT

Methods and apparatuses for processing data are provided. In one embodiment, a data processing operation which is assigned a predefined maximum duration is started. The progress of the data processing operation is checked at a predefined point in time and a priority of the data processing operation is changed on the basis of the progress of the data processing operation.

### BACKGROUND

The present invention relates to methods and apparatuses for processing data.

Different approaches are pursued in order to speed up the processing of data in computer systems. One approach is so-called multithreading in which a changeover is made between the processing of two or more so-called threads at short intervals on a processor instead of processing the threads in a sequential manner which is also referred to as quasi-parallel processing. Examples of such multithreading are so-called coarse-grained multithreading or so-called fine-grained multithreading. This makes it possible to reduce times in which the processor or other components is/are not operating on account of waiting times (so-called processor stall periods) and thus to make more effective use of resources.

However, the quasi-parallel processing of a plurality of threads on a processor makes it difficult to predict how long it will take until the processing of a particular thread has been concluded. This may be problematic in real-time applications, for example.

A similar problem may arise in processors which have a plurality of processor cores for processing data, the processor cores sharing external elements, for example cache memories (level 1 cache, level 2 cache). Also in this case the duration of a process on one of the processor cores may depend on the amount of time needed by another process on another processor core to access said external elements, as a result of which the time needed to execute the process is more difficult to predict. This may also be problematic in real-time applications in which a process must be concluded at a particular point in time. A similar situation may generally apply to multiprocessor systems.

### SUMMARY

One embodiment of a method according to the invention comprises: starting a data processing operation which has a predefined maximum duration, checking the progress of the data processing operation at a predefined point in time before the maximum duration expires, and changing a priority of the data processing operation on the basis of the progress of the data processing operation.

Other embodiments may comprise additional and/or alternative features.

### BRIEF DESCRIPTION OF THE DRAWINGS

The invention is explained in more detail below using embodiments and with reference to the accompanying drawing, in which:

FIG. 1 shows a diagram for illustrating an option for multithreading in some embodiments of the invention,

FIG. 2 shows a diagram for illustrating an embodiment of a method according to the invention,

FIG. 3 shows a block diagram of an embodiment of an apparatus according to the invention,

FIG. 4 shows a block diagram of a further embodiment of an apparatus according to the invention,

FIG. 5 shows a block diagram of another embodiment of an apparatus according to the invention,

FIG. 6 shows a block diagram of a further embodiment of an apparatus according to the invention,

FIG. 7 shows a block diagram of another embodiment of an apparatus according to the invention, and

FIG. 8 shows a block diagram of a further embodiment of an apparatus according to the invention.

### DETAILED DESCRIPTION OF THE INVENTION

Embodiments of the invention are explained in detail below. These embodiments serve merely as examples and are not to be construed as limiting the scope of the present invention, which may be practiced also in other forms than the embodiments described hereinafter and shown in the drawings. Some terms which are used are first of all defined:

Within the scope of this application, the term “data processing operation” includes any type of data processing operation, for example a thread in a multithreading system, a data processing process or task running on a processor or processor core, for example a task of a multitasking system, or operations of accessing elements of a data processing system such as memories or bus systems.

The term “parallel” or “parallel processing” with regard to data processing operations includes both actually parallel processing with a plurality of processor cores or processors and quasi-parallel processing, for example in the case of multithreading in which a changeover is made between a plurality of threads in quick succession.

In the case of the parallel processing of a plurality of data processing operations, a “priority” of a data processing operation indicates which data processing operations are processed in a preferential manner over other data processing operations. In the context of this application, a high priority signifies preferential processing over a low priority. It should be noted that, if the priority is expressed using digits or numbers, for example, a low digit or number may also signify a high priority in this sense and a high digit or number may signify a low priority depending on the system, for example.

Within the scope of this application, a “data processing system” refers to any type of data processing systems, for example computers such as home computers or mainframe computers but also computers or logic circuits which are constructed, for example, on the basis of application-specific modules (ASICs).

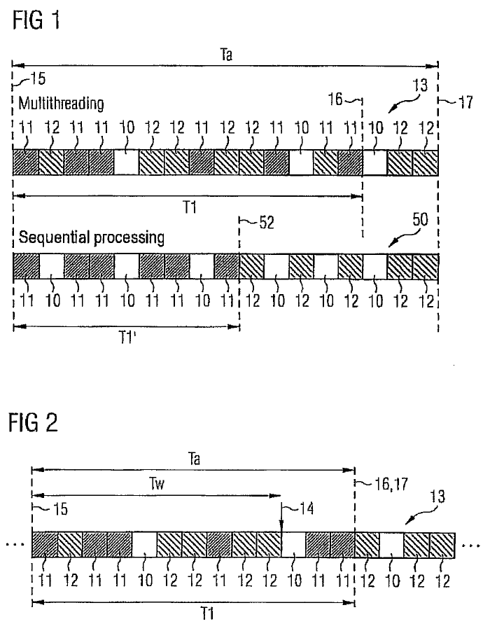

Embodiments of the invention, in which a plurality of threads are executed, for example on a so-called multithreading processor, using multithreading, will now be described. Such multithreading is illustrated, by way of example, in FIG. 1.

Denoted generally with reference symbol 13, FIG. 1 diagrammatically illustrates the processing of two threads in time steps, each time step being represented by a small box. Such a time step may comprise one or more clock cycles of a corresponding multithreading processor.

Two threads are executed in the example illustrated, a first thread being denoted with the reference numeral 11 and a second thread being denoted with the reference numeral 12. In the example illustrated, the threads 11, 12 are started at a point in time which is indicated by a vertical line 15.

Reference numeral 10 is used to denote time steps in which the processor executes neither the first thread 11 nor the second thread 12, for example because it is necessary to wait for events such as memory access operations, results from other units, inputs and the like (so-called stall periods).

As can be seen in FIG. 1, a changeover is made between the threads 11 and 12 during multithreading. In embodiments of the invention, the changeover operation may take place, for example, on the basis of a priority of the threads and/or on the basis of a time since the last execution of the thread. If two threads have the same priority, they may be alternately executed, for example. If one thread has a higher priority than another thread, it is executed more frequently than the other thread. For example, each thread may be allocated a priority value and the time since the last execution of the thread can be added to this priority value. The thread with the higher total value is then executed in the next time step. For the changeover operation, it is also possible to take into account whether resources needed to execute a thread are available.

In the example shown in FIG. 1, thread 11, for example, is a real-time thread which must be concluded within a period Ta, that is to say by the point in time indicated by a vertical dashed line 17, in order to ensure real-time processing. In the example illustrated, the thread 11 is concluded after a time T1, that is to say by a point in time 16 which is before the point in time 17, with the result that no real-time violation occurs.

As a comparative example and generally denoted with 50, the lower half of FIG. 1 illustrates sequential processing of the threads 11, 12, the thread 11 being executed first and the thread 12 then being executed. The time T1′ needed to execute the thread 11 is shorter in this case but fewer steps of the thread 12 are executed within the period Ta on account of more stall periods 10, with the overall result that sequential processing takes longer than multithreading in the example illustrated.

It should be noted that only two threads have been illustrated in FIG. 1 for the purpose of simplification. However, such multithreading is also possible with more than two threads between which a changeover is made.

In the example in FIG. 1, the time T1 needed to execute the thread 11 is also dependent on the thread 12 or generally on other threads, with the result that, without further measures, the time T1 may also exceed the time Ta, depending on the execution of other threads, with the result that a real-time violation may occur.

FIG. 2 schematically illustrates a diagram for illustrating an embodiment of a method according to the invention which is based on such multithreading. Elements which correspond to elements in FIG. 1 are denoted with the same reference numerals as in FIG. 1.

In the embodiment of the method, which is illustrated in FIG. 2, the progress of a real-time thread, which should be executed within a period Ta in order to avoid a real-time violation, is checked after a time Tw, Tw<Ta, during execution of the thread. In this case, an embodiment checks, for example, whether a predefined number of instructions or program steps of the real-time thread have been executed. If this is not the case, the priority of the real-time thread is increased, with the result that it is executed in a preferential manner. This operation is illustrated by way of example in FIG. 2. In this case, thread 11 is a real-time thread which is started at a point in time 15 and should be executed by a point in time 17 within a time Ta. In order to be executed, the thread 11 requires in this case 6 time steps which are respectively indicated by small boxes. In the example illustrated, the time Ta corresponds to thirteen such time steps.

As already explained with reference to FIG. 1, a thread 12 is executed in parallel with the thread 11. In the example, the predefined time Tw after which the progress of the real-time thread is checked corresponds to ten time steps. The progress of the thread 11 is thus checked at the point in time indicated by arrow 14.

In the example illustrated, a check is carried out, for example, after the period of time Tw, in order to determine whether a number of instructions of the task 11 corresponding to five time steps have already been executed. Since only four time steps of the task 11 have been executed at this point in time in the example illustrated, the priority of the thread 11 is increased, with the result that the thread 11 is executed in a preferential manner, as illustrated, after the point in time indicated by the arrow 14. The thread 11 has thus been completely executed at the point in time 16, which corresponds to the point in time 17 in this case, with the result that the predefined maximum processing time Ta is complied with and no real-time violation occurs.

It goes without saying that the numerical examples given with reference to FIG. 2 for the times Ta, Tw and for the number of instructions which must have been executed after expiry of Tw should be understood merely as an illustrative example and can be selected, in particular, on the basis of the threads being considered in a particular implementation.

In the embodiment explained above with reference to FIG. 2, the progress of a thread is checked after a time Tw after the thread has been started. In another embodiment, such a check can be carried out at a plurality of points in time. In yet another embodiment, the points in time at which a check is carried out can be determined on the basis of the latest permitted end of the thread, that is to say after expiry of the time Ta, for example a predefined number of time steps before the point in time 17 which, in FIG. 2, indicates the expiry of the time Ta.

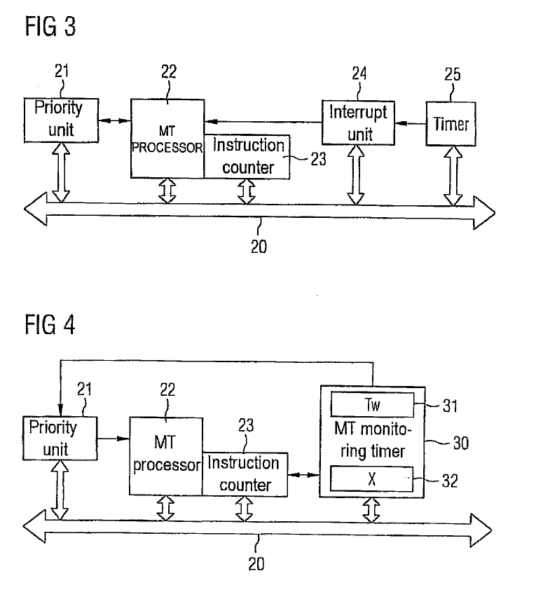

FIG. 3 illustrates a block diagram of an embodiment of an apparatus according to the invention which can be used, for example, to implement the embodiment of a method which was explained above with reference to FIG. 2, but also other methods according to other embodiments of the invention. In this case, the embodiment illustrated in FIG. 3 represents part of a data processing system in which components are connected by means of a bus 20. The apparatus illustrated in FIG. 3 comprises a multithreading processor 22 as an example for data processing circuitry, a priority unit 21, an instruction counter 23, an interrupt unit 24 and a timer 25 which respectively communicate by means of bus 20. Furthermore, in the embodiment shown, as illustrated by arrows, the timer 25 can communicate directly with the interrupt unit 24, the interrupt unit 24 can communicate directly with the multithreading processor 22 and the priority unit 21 can likewise communicate directly, that is to say without using bus 20, with multithreading processor 22. A data processing system which comprises the apparatus illustrated in FIG. 3 may comprise, in an embodiment, further components (not illustrated) such as memories, interfaces and the like which may likewise communicate by means of the bus 20.

Two or more threads may be processed in a parallel manner on the multithreading processor 22, as has already been explained with reference to FIG. 1. In this case, different types of multithreading, for example coarse-grained multithreading, fine-grained multithreading or simultaneous multithreading, may be used. The multithreading processor 22 comprises the instruction counter 23 which counts the number of instructions of a thread which have already been executed.

The sequence in which the threads are processed (scheduling) is controlled, in the embodiment shown, by the priority unit 21 on the basis of priorities of the individual threads.

In the embodiment in FIG. 3, the timer 25 is started when a real-time thread is started. After a predefined time, for example the time Tw from FIG. 2, has expired, the timer 25 drives the interrupt unit 24 to trigger an interrupt on the multithreading processor 22. In a corresponding interrupt routine (interrupt handler), the value of the instruction counter for the real-time thread is then compared with a predefined value of instructions. If the number of instructions which have already been executed is less than the predefined value, the priority of the real-time thread is increased by the multithreading processor 22 informing the priority unit 21 of a correspondingly higher value. The timer 25, the interrupt unit 24 and the processor 22 therefore serve as evaluation circuitry to evaluate the progress of the thread in this embodiment. In other embodiments, other possible evaluation circuitry may be used as will be described below.

The instruction counter 23 may be an instruction counter which is already present anyway in the multithreading processor 22. In another embodiment, the instruction counter is in the form of a program routine which calculates the number of instructions using a program counter in the multithreading processor 22. In yet another embodiment, the instruction counter 23 may be fully implemented in the form of a program routine.

FIG. 4 illustrates a block diagram of a further embodiment of an apparatus according to the invention. Elements of the apparatus in FIG. 4, to which elements in FIG. 3 correspond, are denoted with the same reference symbols.

The apparatus illustrated in FIG. 4 comprises a bus 20, a priority unit 21, a multithreading processor 22 and an instruction counter 23 which correspond to the corresponding elements from FIG. 3 and are therefore not described again. Furthermore, the apparatus illustrated in FIG. 4 comprises a multithreading monitoring timer 30. The multithreading monitoring timer 30 has a memory 31 in order to store a value of the time Tw, which is assigned to a thread, for example a real-time thread, and after which the progress of the thread is checked, and a memory 32 in order to store a comparison value X which corresponds to the predefined value already mentioned, that is to say the number of instructions intended to be executed by the time Tw. In an embodiment, the memories 31 and 32 may be in the form of a joint memory. In yet another embodiment, these values may be stored in a general memory (not illustrated) to which the multithreading monitoring timer has access.

In the embodiment in FIG. 4, the multithreading monitoring timer is started when a real-time thread is started and accesses the instruction counter 23 after the time Tw has expired in order to compare the number of executed instructions of the thread with the comparison value X. If the number of executed instructions is less than X, the multithreading monitoring timer 30 directly writes a higher priority for the thread to the priority unit 21 in the apparatus from FIG. 4, with the result that the priority of the real-time thread is increased and the thread is thus executed in a preferential manner.

In the embodiments in FIGS. 3 and 4, an individual thread, for example a real-time thread, is respectively handled. It goes without saying that, instead of a real-time thread, another thread which is preferably intended to be executed within a certain period of time can also be handled in a similar manner. In another embodiment, a plurality of threads, for example real-time threads, are monitored. For this purpose, a time Tw may be stored for each thread in the memory 31 and a comparison value X may be stored for each thread in the memory 32, for example in the case of an embodiment based on the embodiment in FIG. 4, wherein the individual times Tw and the individual comparison values X may be the same, but may also be partially or entirely different.

In another embodiment, a plurality of times Tw and, accordingly, a plurality of comparison values X are additionally or alternatively stored for an individual thread, with the result that the progress of the thread is checked at a plurality of times Tw and the priority may be increased on the basis of a comparison of the executed instructions with the respective value X.

In yet another embodiment, a comparison value Y which is likewise stored in the memory 32, for example in the case of an embodiment based on the embodiment in FIG. 4, is additionally or alternatively predefined for each time Tw. In such an embodiment, the priority of the thread is decreased if the number of executed instructions of the thread at the point in time Tw exceeds the value Y. In one embodiment, Y is greater than X for the respective value Tw, whereas, in another embodiment, Y may also be equal to X.

As explained with reference to FIG. 4, the priority unit 21 controls the sequence or selection of the processing of the threads on the multithreading processor 22. In another embodiment, the priority unit 21 may additionally or alternatively control operations for accessing further units, for example a cache memory of the multithreading processor 22 or an external memory. For example, an area of a cache memory may be blocked for a thread of low priority, with the result that preference is given to threads of higher priority, which have access to the entire cache memory.

FIG. 5 illustrates a further embodiment of an apparatus according to the invention which, like the embodiments in FIGS. 3 and 4, may be implemented as part of a data processing system.

The embodiment illustrated in FIG. 5 is a multiprocessor system comprising a first processor 41 and a second processor 43 which are another example of data processing circuitry. Other embodiments may also comprise more than two processors. The first processor 41 is assigned a first instruction counter 42 and the second processor 43 is assigned a second instruction counter 44. The instruction counters 42, 44 can each be implemented as already explained with reference to FIG. 3 for the instruction counter 23 and count a number of executed instructions of a process or task running on the respective associated processor 41 or 43.

The processors 41 and 43 are assigned joint hardware 46, for example a joint level 2 cache, joint interfaces etc. The hardware 46 may also comprise a bus which is jointly used by the processors 41 and 43 or any other type of jointly used hardware. Access of the processors 41 and 43 to the hardware 46 is controlled by a priority unit 47. For example, a priority value may be respectively assigned to the processes running on the processors 41, 43 and that processor on which the process of higher priority is running is allowed to access the hardware 46 more frequently, for example. In the case of a cache memory, a data processing operation of higher priority may access larger memory areas than a data processing operation of low priority in an embodiment. In the case of a bus system, a higher priority increases the likelihood of permission to access the bus in an embodiment. Other possibilities are also conceivable; for example, the possible ways of controlling priority for a plurality of threads in multithread processors, which have already been discussed with reference to FIGS. 2-4, can be applied in a corresponding manner to access to the hardware 46 by different processes running on the processors 41, 43.

The components of the apparatus shown in FIG. 5 are connected to or coupled with one another and, if appropriate, to/with other components (not illustrated), such as memories, interfaces and the like, by means of a bus system 40.

In the embodiment in FIG. 5, a real-time process or another process which is intended to be executed in a predefined time may run on the first processor 41 and/or the second processor 43. In order to monitor the progress of such processes, the apparatus illustrated in FIG. 5 has a monitoring timer 45. The monitoring timer has a memory 48 for storing one or more periods of time Tw1 for the first processor 41 and one or more periods of time Tw2 for the second processor 43. Furthermore, in the embodiment illustrated, the monitoring timer 45 comprises a memory 49 for storing one or more comparison values X1 for the first processor 41 and one or more comparison values X2 for the second processor 43. When a real-time process, for example, is started on the first processor 41, the monitoring timer 45 is informed of the start of the process by the instruction counter 42. After the time Tw1 has expired, the monitoring timer 45 interrogates the first instruction counter 42 and compares the number of executed instructions with the comparison value X1. If the number of executed instructions is less than X1, the monitoring timer 45 informs the priority unit 47 that the priority of the first processor 41 or of the process running on the first processor 41 is to be increased, for example by writing a higher priority to the priority unit 47. The monitoring timer 45 may monitor a process running on the second processor 43 in a corresponding manner, the period of time Tw2 and the comparison value X2 being used for this purpose.

In the embodiments in FIGS. 2-5, the progress of a data processing operation is checked after a predefined time has expired or at particular points in time, for example by comparing a number of executed instructions with a predefined threshold value. In another embodiment, the progress of a data processing operation is checked relative to the progress of another data processing operation and priorities of the data processing operations are adapted in a corresponding manner.

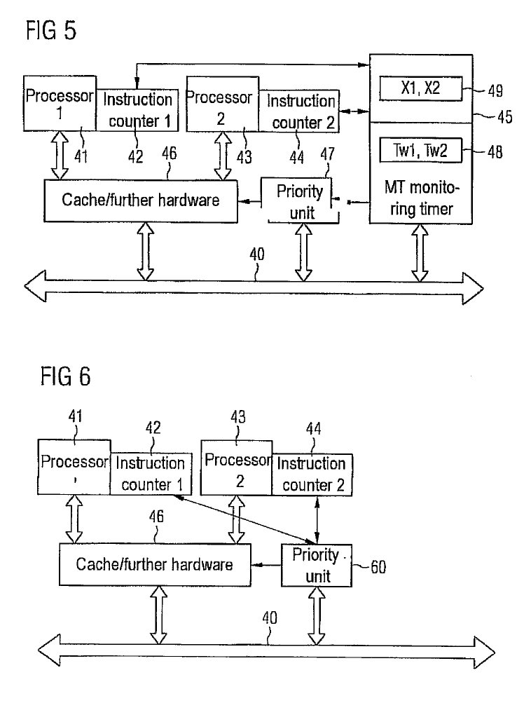

FIG. 6 illustrates such an embodiment. Elements of the embodiment in FIG. 6 which correspond to elements of the embodiment in FIG. 5 have the same reference symbols and are not explained in detail again. Like the embodiment in FIG. 5, the embodiment illustrated in FIG. 6 thus comprises a bus 40, a first processor 41, a first instruction counter 42 assigned to the first processor, a second processor 43, a second instruction counter 44 assigned to the second processor 43 as well as hardware 46 such as a cache memory which is jointly accessed by, i.e. shared by, the first processor 41 and the second processor 43, the access duration or times of the processors 41, 43 being managed in a priority-controlled manner.

For this priority control, the apparatus from FIG. 6 comprises a priority unit 60. In the embodiment in FIG. 6, the priority unit 60 reads the first instruction counter 42 and the second instruction counter 44, that is to say a number N1 of executed instructions of a process on the first processor 41 and a number N2 of executed instructions of a process on the second processor 43. The priorities of the process on the first processor 41 and of the second processor 43 are then changed on the basis of N1 and N2.

In an embodiment, that process in which fewer instructions are executed may respectively receive the higher priority, for example. An identical processing speed may thus be approximately achieved.

In another embodiment, it is likewise possible to regulate the ratio N1/N2 to any desired value c. In one embodiment of the invention, the ratio N1/N2 is compared with c for this purpose. If N1/N2 is greater than c, the priority of the process on the second processor 43 is increased, and if N1/N2 is less than c, the priority of the process on the first processor 41 is increased.

In another embodiment, a value other than the ratio of N1 and N2 may also be regulated to a constant value of the general form f(N1, N2)=c, where f expresses any desired functional dependence.

In a further embodiment, the time t may also be concomitantly taken into account, for example a time value provided by a timer (not shown) which is integrated in the priority unit 60 or another element of the apparatus. In one embodiment, the priorities of the processes may generally be controlled in such a manner that f(t, N1, N2)=c, f being a function of t, N1 and N2. Such a dependence makes it possible, for example during a first time segment, to give preference to a process on the first processor 41, whereas preference is given to a process on the second processor 43 in a subsequent second time segment, that is to say the priorities are controlled in such a manner that more instructions of the respective preferred process are executed.

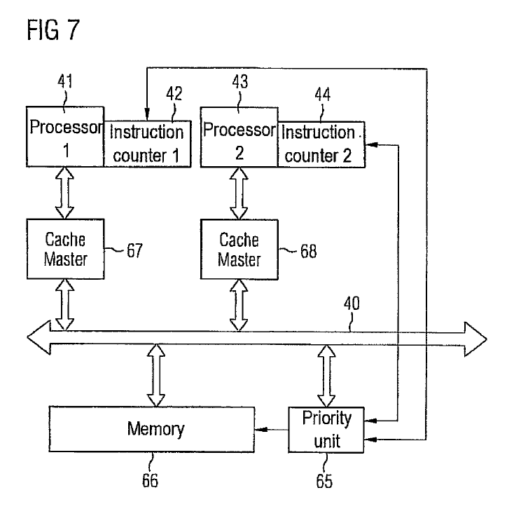

In the embodiment in FIG. 6, the priority unit 60 controls access to, or the use of, hardware 46 which is directly accessed by the first processor 41 and the second processor 43. In another embodiment, such a priority unit is used to control access to further hardware via the bus 40. A corresponding embodiment is illustrated in FIG. 7.

In the embodiment in FIG. 7, the bus 40, the first processor 41, the first instruction counter 42, the second processor 43 and the second instruction counter 44 correspond to the components which have already been described with reference to FIGS. 5 and 6 and are therefore not explained again.

In the embodiment in FIG. 7, the first processor 41 is assigned a cache master 67 and the second processor 43 is assigned a cache master 68.

In the embodiment in FIG. 7, a memory 66 is also connected to the bus 40. The memory 66 may be, for example, an external SDRAM, a flash memory or else an internal SRAM. Access of the processors 41, 43, if appropriate via the cache masters 67 and 68, to the memory 66 by means of the bus 40 is controlled by a priority unit 65 which reads the first instruction counter 42 and the second instruction counter 44 and, on the basis thereof, changes the priority of the corresponding processes on the first processor 41 and the second processor 43 for access to the memory 66. This can be carried out in the manner already explained with reference to FIG. 6 for the priority unit 60.

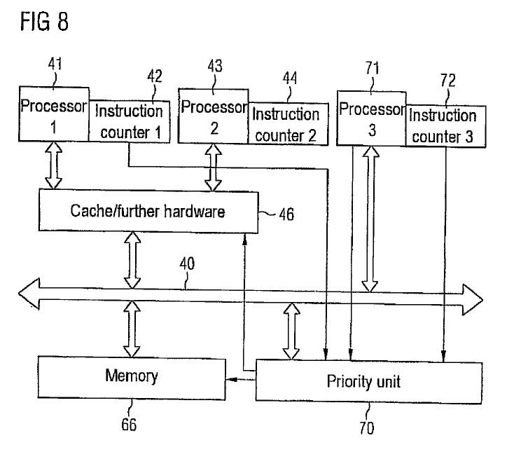

The embodiments in FIGS. 5-7 respectively comprise a first processor 41 and a second processor 43. In another embodiment of the invention, more than two processors may also be provided. In addition, in an embodiment, a priority unit may control access to different components. A corresponding embodiment which combines these two aspects which also may be implemented separately is illustrated in FIG. 8.

In the embodiment in FIG. 8, the bus 40, the first processor 41, the first instruction counter 42, the second processor 43, the second instruction counter 44 and the hardware 46 correspond to the components already described with reference to FIGS. 5 and 6. The hardware 46 may for example be a cache memory which is jointly accessed by the first processor 41 and the second processor 43, i.e. which is shared by processors 41 and 43.

Furthermore, the embodiment in FIG. 8 comprises a memory 66 as already described with reference to FIG. 7.

In addition, the embodiment in FIG. 8 comprises a third processor 71 having a third instruction counter 72. A priority unit 70 reads the first instruction counter 42, the second instruction counter 44 and the third instruction counter 42 and, on the basis thereof, controls access of the first processor 41 and of the second processor 43 to the hardware 46 as well as access of the processors 41, 43 and 71 to the memory 66. In one embodiment, access to the hardware 46 is controlled as described with reference to FIG. 6. In order to control access to the memory 66, the method described with reference to FIGS. 6 and 7 may be extended to the effect that a number of executed instructions N3 of a process running on the third processor 71 is also incorporated, that is to say a function g(N1, N2, N3) is regulated to a predefined value c, wherein the function g may, but need not additionally depend on the time t.

The present invention is not restricted to the embodiments illustrated. For example, more than three processors may also be present. In a similar manner, more than two threads may also be managed on a multithreading processor in the embodiments in FIGS. 2-4.

The extensions and modifications discussed with reference to FIGS. 3 and 4 can also be implemented in the embodiments in FIGS. 5-8. For example, the progress of a process running on the first processor 41 and/or a process running on the second processor 43 may be checked at a plurality of points in time in accordance with a plurality of times Tw1 with correspondingly associated comparison values X1, as a result of which the priority of the processor or of the process running on the latter is increased several times, if appropriate. A comparison with additional comparison values Y1, Y2 corresponding to the comparison value Y which has already been discussed may also be implemented in one embodiment, the priority being accordingly decreased if the number of executed instructions exceeds the corresponding value Y1 or Y2. In principle, another embodiment of the invention may also only check whether the number of executed instructions of a data processing operation exceeds a predefined value and, if so, can decrease the priority of the data processing operation.

In the embodiments in FIGS. 3-5, different units are represented by different blocks in the figures. These units or blocks may be implemented in separate modules but may also be integrated on common chips or in common modules. For example, the priority unit 21 in FIGS. 3 and 4 may be integrated in the multithreading processor 22 in FIGS. 3 and 4. The monitoring timers 30, 45 may also be integrated in one of the processors of the respective apparatus but may likewise be implemented in the form of independent modules which can be used with different processors. The processors 41, 43 of the embodiments in FIGS. 5-8 may also be in the form of separate processors but may also represent different processor cores of a multicore processor. Further modifications are also conceivable.

For example, the embodiments in FIGS. 3 and 4 may be combined with one of the embodiments in FIGS. 5-8 by virtue of one or more of the processors 41, 43 and 71 being in the form of multithreading processors like the multithreading processor 22 from FIG. 4. In this case, one or more priority units may be used to control both access of the processors to the hardware 46 and the priority of the different threads running on a processor, and one or more monitoring timers or else a solution as illustrated in FIG. 3 may be used to monitor the threads, for example real-time threads. Instead of the monitoring timer 45 in FIG. 5, a combination of a timer and an interrupt unit as illustrated in FIG. 3 may also be implemented. In another embodiment, a monitoring timer as illustrated in FIG. 5 may be combined with a priority unit as explained in FIGS. 6-8. For example, in an embodiment similar to the embodiment illustrated in FIG. 8, access of the first processor 41 and of the second processor 43 to the hardware 46 may be controlled using a monitoring timer such as the monitoring timer 45 from FIG. 5, whereas access to the memory 66 is controlled only using a priority unit which reads the respective instruction counters of the processors.

Therefore, the present invention is not restricted to the embodiments described which are used only to illustrate the invention, but the scope is intended to be defined only by the appended claims and equivalents thereof.

What is claimed is:

1. A method for processing data, comprising:
starting a data processing operation which is assigned a predefined maximum duration,
checking the progress of the data processing operation at a predefined point in time before the maximum duration expires, and
changing a priority of the data processing operation on the basis of the progress of the data processing operation.

2. The method of claim 1,
wherein the data processing operation is selected from the group comprising a thread in a multithreading system, a process in a multiprocessor system and a task in a multiprocessor system.

3. The method of claim 1, wherein checking the progress of the data processing operation comprises comparing a number of executed instructions of the data processing operation with at least one predefined comparison value.

4. The method of claim 3,
wherein the at least one predefined comparison value comprises a first comparison value,
the priority of the data processing operation being increased if the number of executed instructions is less than the first comparison value.

5. The method of claim 3,
wherein the at least one predefined comparison value comprises a second comparison value,
the priority of the data processing operation being decreased if the number of executed instructions is greater than the second predefined comparison value.

6. The method of claim 1,
wherein checking the progress comprising checking the progress at a plurality of predefined points in time before the maximum duration expires, and
wherein changing the priority of the data processing operation comprising changing the priority of the data processing operation at any predefined point in time on the basis of the progress of the data processing operation.

7. The method of claim 1,
wherein the predefined point in time is a predefined period of time after the data processing operation has been started.

8. A method for processing data, comprising:
executing a first data processing operation and a second data processing operation in parallel to the first data processing operation,
determining the progress of the first data processing operation and the progress of the second data processing operation, and
changing a priority of the first data processing operation and/or a priority of the second data processing operation depending on the progress of the first data processing operation and the progress of the second data processing operation.

9. The method of claim 8,
wherein determining the progress comprising determining a number of executed instructions of the first data processing operation and a number of executed instructions of the second data processing operation.

10. The method of claim 8,
wherein the priority of the first data processing operation and/or the priority of the second data processing operation are changed in such a manner that a function of the progress of the first data processing operation and of the progress of the second data processing operation is regulated to a predefined value.

11. The method of claim 8, further comprising
controlling access to a hardware component selected from the group comprising a cache memory, an external memory and a bus depending on the priority.

12. An apparatus for processing data, comprising:
data processing circuitry, and
evaluation circuitry for checking the progress of a data processing operation being executed on the data processing circuitry, the evaluation circuitry being configured to check a progress of the data processing operation at a predefined point in time before a predefined maximum duration of the data processing operation expires and to change a priority of the data processing operation on the basis of the progress of the data processing operation.

13. The apparatus of claim 12,
wherein the evaluation circuitry comprises a timer and an interrupt controller, the evaluation circuitry being configured such that the timer, after a predefined period of time following the start of the data processing operation has expired, drives the interrupt controller to trigger an interrupt on the data processing circuitry, whereupon the data processing circuitry checks the progress of the data processing operation.

14. The apparatus of claim 12,
wherein the evaluation circuitry comprises an instruction counter for counting a number of executed instructions of the data processing operation, and
wherein the operation of checking the progress comprises comparing the number of executed instructions with a predefined comparison value.

15. The apparatus of claim 12, wherein the evaluation circuitry is at least partially identical to the data processing circuitry.

16. The apparatus of claim 12,
the evaluation circuitry being configured to directly change a priority of the data processing operation without using the data processing circuitry.

17. The apparatus of claim 12,
wherein the evaluation circuitry comprises at least one separate module.

18. The apparatus of claim 12,
wherein the data processing circuitry comprises a multithreading processor.

19. The apparatus of claim 12,
wherein the data processing circuitry comprises at least two processor units,
the at least two processor units being configured to access shared hardware components on the basis of priorities of data processing operations running on the processor units.

20. The apparatus of claim 12,
the apparatus being configured to process real-time data processing operations.

21. An apparatus for processing data, comprising:
data processing circuitry for parallel execution of a first data processing operation and a second data processing operation, and
evaluation circuitry configured to determine a progress of the first data processing operation and of the second data processing operation and to change a priority of the first data processing operation and/or a priority of the second data processing operation on the basis of the progress of the first data processing operation and the progress of the second data processing operation.

22. The apparatus of claim 21,
wherein the data processing circuitry comprises a multithreading processor.

23. The apparatus of claim 21,
wherein the data processing circuitry comprises at least two processor units,
the at least two processor units being configured to access shared hardware components on the basis of priorities of data processing operations running on the processor units.
